(19) United States
(12) Patent Application Publication
(10) Pub. No.: US 2017/0079280 A1
(43) Pub. Date: Mar. 23, 2017

(54) HIGH-PERFORMANCE ANTI-FUNGAL, ANTI-BACTERIAL, INSECTICIDAL AND DEODORIZING MICROCAPSULE, AND APPLICATION THEREOF

(71) Applicant: Profession Chemical Industry Co., Ltd., Dongguan City (CN)

(72) Inventor: Wen-Ting Chen, Dongguan City (CN)

(21) Appl. No.: 14/862,162

(22) Filed: Sep. 23, 2015

(51) Int. Cl. A01N 65/28; A01N 35/02; A01N 31/08; A01N 33/16; A01N 55/02; A01N 59/00; A01N 43/16; A01N 37/06; A01N 53/00; A01N 43/50; A01N 65/24; A01N 37/02; A01N 33/26; D21H 21/36; D21H 21/14; D21H 21/54; A01N 35/06

(52) U.S. Cl. CPC A01N 65/28; A01N 35/06; A01N 35/02; A01N 31/08; A01N 33/16; A01N 55/02; A01N 59/00; A01N 43/16; A01N 37/06; A01N 53/00; A01N 43/50; A01N 65/24; A01N 37/02; A01N 33/26; D21H 21/36; D21H 21/14; D21H 21/54; D21H 5/22

(57) ABSTRACT

Disclosed are a high-performance anti-fungal, anti-bacterial, insecticidal and deodorizing microcapsule and its application. The functional microcapsule includes the following raw materials in parts by weight: a constant-temperature sublimation agent of 40˜50 parts by weight, an anti-bacterial agent of 10˜15 parts by weight, a deodorant of 10˜15 parts by weight, an insecticide of 10˜15 parts by weight, an anti-fungal agent of 10˜15 parts by weight, a solvent of 100 parts by weight, a release agent of 600˜1000 parts by weight, a diluent of 6000˜10000 parts by weight, and an emulsifier of 0.2˜0.25 part by weight.

### TECHNICAL FIELD

The technical field relates to shoes package and storage boxes, and more particularly to a high-performance anti-fungal, anti-bacterial, insecticidal and deodorizing microcapsule and its application, and various kinds of chemical agents and carriers are added or attached onto the inner surface of the package box to achieve the anti-fungal, anti-bacterial, and deodorizing effects, and the chemical agents and carriers are made of constant-temperature sublimable volatile substances and film formers.

### BACKGROUND

In early time, most shoes product packages taking costs into consideration were made of saturated monobasic aldehydes such as formaldehyde (formalin). Since these shoes product packages are considered as carcinogenic and teratogenic substances by World Health Organization and recognized as the sources of allergy as well as one of the most potential mutagens, therefore the using content is strictly restricted to a range≦(20 mg/kg) for infant products and a range≦(75mg/kg) for products in direct contact with skin. Under such limitation ranges, it is difficult to achieve the expected anti-fungal effect during the process of packaging and storing shoes products. Therefore, most manufacturers changed the raw material to dimethyl fumarate (DMF) which is the primary substance for the anti-fungal effect. However, DMF also causes damage to human health. According to clinical experiments, DMF may cause inflammation by the inhalation through esophagus and result in human intestinal and visceral corrosive damages, and after such substance is in contact with skin, DMF may cause contact dermatitis and pain such as itching, irritation, redness, and burn, and thus jeopardizing human health tremendously. Therefore, the European Product Safety Commission passed the decision of banning the use of dimethyl fumarate (DMF) on Jan. 29, 2009 by way of poll and requested for the approval of by the European Product Safety Commission. On Mar. 17, 2009, the European Product Safety Commission announced Directive 2009/251/EC of banning the use of DMF and specified the maximum limit of using DMF in a product to 0.1 mg/kg, and thereafter American Apparel and Footwear Association (AAFA) also announced the restricted substances list RSL Version 4 which includes the DMF banned by the European Product Safety Commission.

Under the strict control and use of formalin and DMF, it gives a headache to related manufacturers to prevent fungal attack to shoes products in the period after being packaged to the time being stored by consumers. In present markets, the substances added to the shoes products for preventing fungal growth are mainly divided into the following two types:

1. Desiccants mainly composed of silica gel, calcium chloride, magnesium chloride, aluminum oxide, molecular sieve, activated carbon, charcoal, or activated clay. These substances mainly attach water molecules on their structures through physical methods to create a dry environment in the limited space, such that fungi will not grow easily. However, such product has the following drawbacks: (A) This product cannot provide a long-term safe protection because the water content of only 8˜15% by weight is absorbed. (B) After saturation, factors including the ambient temperature and the self deliquescence may regain moisture and produce fungi and molds if the desiccant is not changed timely. (C) No air is allowed in the package, and thus desiccants are just applicable for closed package only. (D) There are concerns about the desiccant being eaten by children by mistake.

2. Anti-fungal tablet is mainly composed of natural mustard oil (commonly known as wasabi extract), but actually composed of “allyl isothiocyanate” (artificial mustard oil). The substance is a strong stimulating gas spread in a specific space and achieving the effect of preventing fungi or molds from growing easily by fumigation. Since the anti-fungal tablet has a strong stimulating volatile smell, it is used for shoes products only so far. However, this substance has several serious problems: (A) “Allyl isothiocyanate” is one of the top listed items in the “List of Hypertoxic Chemicals” (Rank 15^{th} among more than 300 items). (B) The powerful toxicity of allyl isothiocyanate may harm animals and humans substantially. (C) The substance achieves the expected effect by the volatile stimulating gas through fumigation, so that if the package is unable to prevent air from entering, the fumigation time is very limited and thus failing to maintain a long-time protection. (D) The composition of “allyl isothiocyanate” fears humid air, so that the dryness in the storage environment, packaged content and package box may be maintained during use, so as to achieve the fumigation function. (E) The substance vaporized from “allyl isothiocyanate” is a yellow acidic gas which may yellow a white packaging material or oxidize (rust) a metal substance. (F) There are concerns about the anti-fungal tablet being eaten by children by mistake.

At present, no multifunctional shoes package box combining the anti-fungal, anti-bacterial, insecticidal and deodorizing effects and providing a long-term effect up to several years is available in the market yet. Such package box no just protects packaged shoes products after their production and packaging only, but also provides an environmentally friendly product provided for shoes manufacturers and consumers to package and store shoes.

### SUMMARY

In view of the drawbacks of the prior art, it is a primary objective of this disclosure to provide a high-performance anti-fungal, anti-bacterial, insecticidal and deodorizing microcapsule and its application with the high-performance anti-fungal, anti-bacterial, insecticidal and deodorizing effects, and such microcapsule with a long term of validity may be used for protecting and packaging shoes products after existing the factory as well as maintaining the hygiene of the shoes products for consumers.

To achieve the aforementioned and other objectives, this disclosure provides a high-performance anti-fungal, anti-bacterial, insecticidal and deodorizing microcapsule comprising the following raw materials in parts by weight: a constant-temperature sublimation agent of 40˜50 parts by weight, an anti-bacterial agent of 10˜15 parts by weight, a deodorant of 10˜15 parts by weight, an insecticide of 10˜15 parts by weight, an anti-fungal agent of 10˜15 parts by weight, a solvent of 100 parts by weight, a release agent of 600˜1000 parts by weight, a diluent of 6000˜10000 parts by weight, and an emulsifier 0.2˜0.25 parts by weight.

In a preferred embodiment, the anti-bacterial agent is hinokitiol, citronellal, thymol, bronopol, pyridine zinc sulfate, stable chlorine dioxide solution, or any mixture of the above.

In a preferred embodiment, the anti-fungal agent is citral, bromo cinnamic aldehyde, clove oil, litsea oil, eucalyptus oil, propionate, O-phenylphenol, dodecyl guanidine hydrochloride, or any mixture of the above.

In a preferred embodiment, the deodorant is chitin, chitosan, glyoxal, glutaraldehyde, maleate, and any mixture of the above.

In a preferred embodiment, the insecticide is empenthrin, imiprothrin, D-phenothrin, or any mixture of the above.

In a preferred embodiment, the constant-temperature sublimation agent is 2,4,6-triisopropylsilyl-1,3,5-three oxygen-dioxane, 2-hydroxy camphor, adamantane, and any mixture of the above.

In a preferred embodiment, the release agent is β-cyclodextrin, gelatin, gum Arabic, shellac, kerria, starch, dextrin, wax, turpentine, alginate, (hydroxyphenyl) methyl cellulose, ethyl cellulose, polyethylene, polystyrene, polybutadiene, polyether, polyurea, polyethylene glycol, polyvinyl alcohol, polyamide, polyacrylamide, polyurethane, polymethyl methacrylate, polyvinylpyrrolidone, epoxy resin, polysiloxane, and any mixture of the above.

In an application of a high-performance anti-fungal, anti-bacterial, insecticidal and deodorizing microcapsule, the functional microcapsule may be added in pulp, and the added amount is equal to 10˜20 parts by weight, and the pulp is used for making paper or corrugated cardboards of different weights, and further manufacturing the sheets of a shoes box.

In an application of a high-performance anti-fungal, anti-bacterial, insecticidal and deodorizing microcapsule, a functional microcapsule with 10˜20 parts by weight and various polymer plastics, natural inorganic mineral powders and functional additives are mixed, banburied, pressed and processed through corona to produce the sheets of a shoes box.

In an application of a high-performance anti-fungal, anti-bacterial, insecticidal and deodorizing microcapsule, a functional microcapsule of 20˜25 parts by weight and a film former of 70˜75 parts by weight are thoroughly stirred and mixed at room temperature and then sprayed or coated onto the inner surface of a shoes box, and the sprayed or coated amount is equal to 600˜800 g per cubic meter.

Compared with the prior art, this disclosure as described above has the following advantages and beneficial effects:

The functional microcapsule is prepared by the formula of this disclosure, and the functional microcapsule is added into pulp to manufacture paper or corrugated cardboards with different weights in grams, or various polymer plastics, natural inorganic mineral powders (such as calcium carbonate, calcium sulfate, barium sulfate, mica, zinc oxide, dolomite, tulcom, etc), and functional additives (such as coupling agents, lubricants, anti-oxidants, anti-static agents and brighteners) are mixed, banburied, and processed by lamination and corona to manufacture sheets for making a shoes box, or a film former is mixed to form a material that can be sprayed or coated onto the inner surface of a shoes box. The shoes package box manufactured in accordance with this disclosure has the high-performance anti-fungal, anti-bacterial, insecticidal and deodorizing effects and such shoes package box is applicable for protecting and packaging the shoe products after exiting the factory due to its long-term of validity as well as maintaining the hygiene of the shoes products for consumers.

More specifically, the structure, technical characteristics and effects of this disclosure will become apparent with the detailed description of preferred embodiments and the illustration of related drawings as follows.

### BRIEF DESCRIPTION OF THE DRAWINGS

FIG. 1 is a sectional view of a preferred embodiment of this disclosure; and

FIG. 2 is a flow chart of the preparation in accordance with a preferred embodiment of this disclosure.

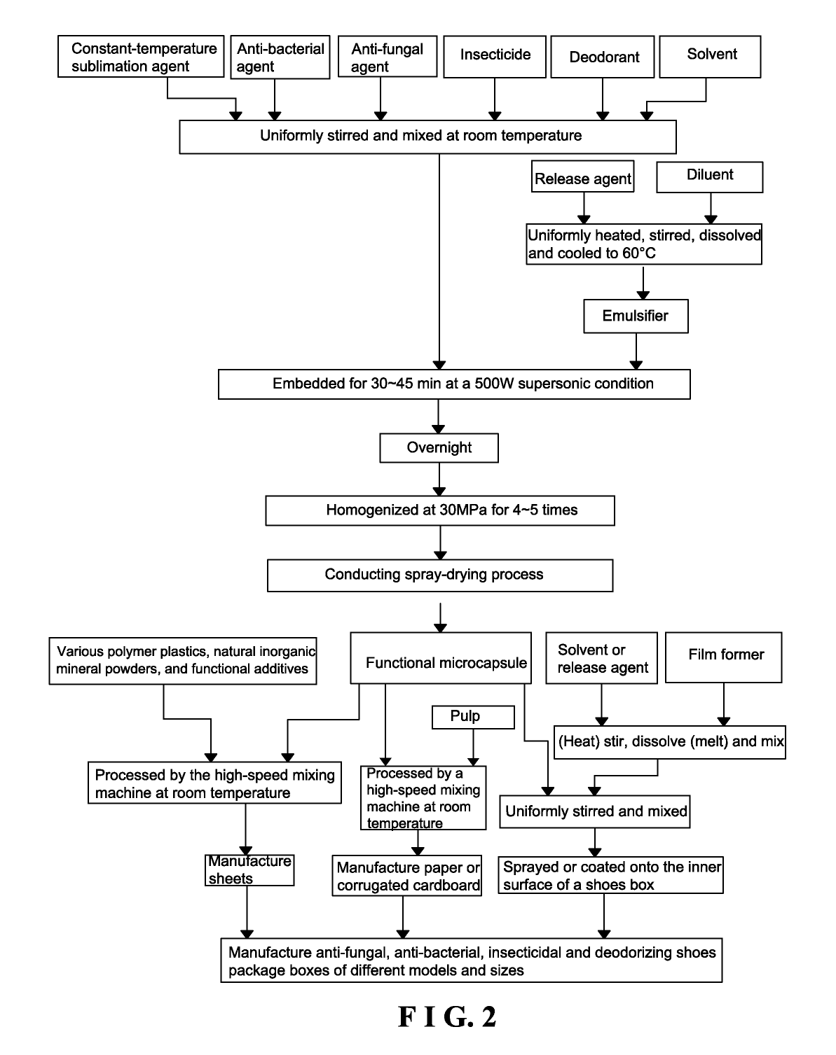

### DESCRIPTION OF THE PREFERRED EMBODIMENTS

The technical content of this disclosure will become apparent with the detailed description of preferred embodiments and the illustration of related drawings as follows.

The objectives of this disclosure can be achieved by the following three methods: 1. A layer of the mixture of a functional microcapsule and a film former is sprayed or coated on the inner surface of the original package box; 2. The functional microcapsule is added into pulp to manufacture paper or corrugated cardboards with different weights in grams and further manufacture shoes package boxes with different models and sizes; 3. The functional microcapsule and various polymer plastics, natural inorganic mineral powders, and functional additives are mixed, banburied, and processed by lamination and corona to manufacture sheets for making shoes package boxes with different models and sizes. The details are described below:

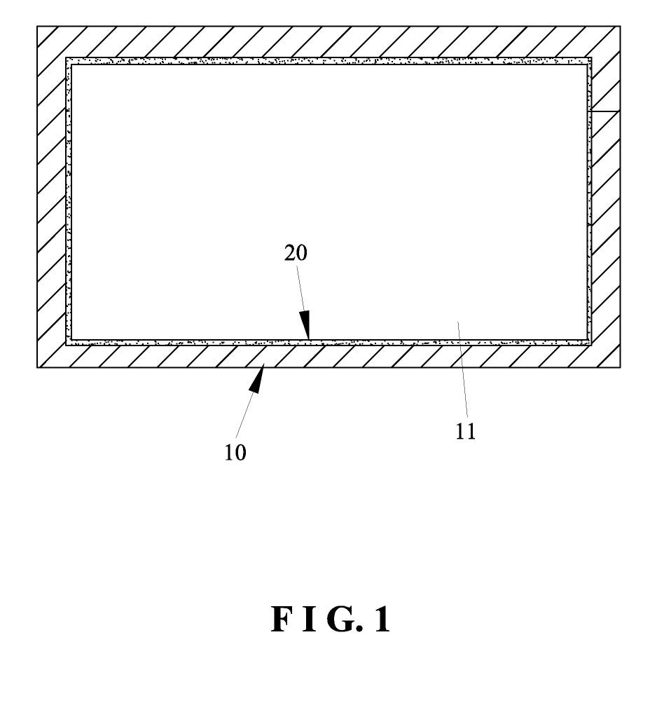

With reference to FIG. 1 for a specific structure with an application of a high-performance anti-fungal, anti-bacterial, insecticidal and deodorizing microcapsule of a in accordance with a preferred embodiment of this disclosure, a layer of functional agent is sprayed or coated onto the inner wall of a containing space 11 of a main body 10 of a package box, wherein the functional agent includes an anti-bacterial agent, an anti-fungal agent, a deodorant, or an insecticide to work with a constant-temperature sublimation agent, and a release agent to prepare a functional microcapsule, and then the functional agent and the film former are mixed to product a mixture which can be sprayed or coated onto the inner surface of a shoes package box to form a thin film 20 capable of releasing an effective composition within a long term of validity. The sprayed/coated amount is calculated according to the volume of the containing space 11 of the package box, which is equal to 600˜800 g per cubic meter.

In another application of a high-performance anti-fungal, anti-bacterial, insecticidal and deodorizing microcapsule, the anti-bacterial agent, anti-fungal agent, deodorant, and insecticide together with a constant-temperature sublimation agent and a release agent are used to manufacture a functional microcapsule, and then the functional microcapsule is mixed with pulp to manufacture paper or corrugated cardboards with different weights in grams, and then manufacture shoes package boxes with different models and sizes. The added amount of functional microcapsule is equal to 10˜20% of the weight of the package box.

In another application of a high-performance anti-fungal, anti-bacterial, insecticidal and deodorizing microcapsule, a functional microcapsule of 10˜20% parts by weight and various polymer plastics, natural inorganic mineral powders such as calcium carbonate, calcium sulfate, barium sulfate, mica, zinc oxide, dolomite, or tulcom and a functional additive such as a coupling agent, a lubricant, an anti-oxidant, an anti-static agent or a brightener are mixed, banburied, and processed by lamination and corona to manufacture sheets for making shoes package boxes with different models and sizes.

In this disclosure, the constant-temperature sublimation agent is one selected from the group consisting of 2,4,6-triisopropylsilyl -1,3,5-three oxygen-dioxane, 2-hydroxy camphor, adamantane, and any mixture thereof; the anti-bacterial agent is one selected from the group consisting of hinokitiol, citronellal, thymol, bronopol, pyridine zinc sulfate, and any mixture thereof; the deodorant is one selected from the group consisting of chitin, chitosan, glyoxal, glutaraldehyde, maleate, and any mixture thereof; the insecticide is one selected from the group consisting of empenthrin, imiprothrin, D-phenothrin, and any mixture thereof; the anti-fungal agent is one selected from the group consisting of citral, bromo cinnamic aldehyde, clove oil, litsea oil, eucalyptus oil, propionate, and any mixture thereof; the solvent is one selected from the group consisting of ethanol; the release agent is one selected from the group consisting of β-cyclodextrin, gelatin, gum Arabic, shellac, kerria, starch, dextrin, wax, turpentine, alginate, (hydroxyphenyl) methyl cellulose, ethyl cellulose, polyethylene, polystyrene, polybutadiene, polyether, polyurea, polyethylene glycol (molecular weight: 4,000˜8,000), polyethylene glycol, polyvinyl alcohol, polyamide, polyacrylamide, polyurethane, polymethyl methacrylate, polyvinylpyrrolidone, epoxy resin, polysiloxane, and any mixture thereof; the diluent is one selected from the group consisting of deionized water or distilled water; and the film former is one selected from the group consisting of water-soluble polyurethane resin, alcohol-soluble acrylic acid resin, rosin resin, water-soluble alkyd resin, water-soluble epoxy resin, polyvinyl alcohol, (hydroxyphenyl) methyl cellulose, (hydroxyphenyl) ethyl cellulose, (hydroxyphenyl) propyl cellulose, polyvinylpyrrolidone, starches adhesive, and any mixture thereof.

In this disclosure, the constant-temperature sublimation agent of 40˜50 parts by weight, the anti-bacterial agent of 10˜15 parts by weight, the deodorant of 10˜15 parts by weight, the insecticide of 10˜15 parts by weight, the anti-fungal agent of 10˜15 parts by weight, and the solvent of 100 parts by weight are mixed to produce a functional mixture prepared for use. Add a release agent of 600˜1000 parts by weight, into a diluent of 6000˜10000 parts by weight, and heat uniformly until they are dissolved, and then cooled to 60° C. before adding an emulsifier of 0.2˜0.25 parts by weight and the functional mixture for embedment overnight at a 500 W supersonic condition, and homogenization takes place at the condition of 30 MPa for 4˜5 times, and then the spray-drying process is conducted to obtain the functional microcapsule.

1. A functional microcapsule of 10˜20% parts by weight and pulp are mixed to manufacture paper or corrugated cardboards with different weights in grams, and further manufacture shoes package boxes with different models and sizes.

2. A functional microcapsule of 10˜20% parts by weight and various polymer plastics, natural inorganic mineral powders, and functional additives are mixed, banburied, and processed by lamination and corona to manufacture sheets for making shoes package boxes with different models and sizes.

3. A functional microcapsule of 25˜30% parts by weight and a film former of 70˜75% parts by weight are thoroughly stirred and mixed at room temperature, and then sprayed or coated onto the inner surface of a shoes box, wherein the sprayed or coated amount is equal to 600˜800 g per cubic meter.

| | | Embodiment | Embodiment | Embodiment | Embodiment | Embodiment | Embodiment | Embodiment | Embodiment |
|---|---|---|---|---|---|---|---|---|---|
| Composition | | 1 | 2 | 3 | 4 | 5 | 6 | 7 | 8 |
| Constant- | 2,4,6-triisopropyl- | 4 | | | 4.2 | | | 4.6 | |
| temperature | silyl-1,3,5-three | | | | | | | | |
| sublimation | oxygen-dioxane | | | | | | | | |
| agent | 2-hydroxy camphor | | 4.5 | | 0.1 | 4.5 | | | 5 |
| | Adamantine | | | 5 | | | 4.8 | | |
| Anti- | Hinokitiol | 1.5 | | | | | | | 0.5 |
| bacterial | Citronellal | | 1.2 | | | | | | |
| agent | Thymol | | | 1.1 | | | | 0.7 | |
| | Bronopol | | | | 1.3 | | | | 0.8 |
| | Pyridine zinc sulfate | | | | | 1.4 | | 0.5 | |
| | Stable chlorine | | | | | | 1.4 | | |
| | dioxide solution | | | | | | | | |
| Deodorant | Chitosan | 1.3 | | | 1 | | 1.1 | 1 | |
| | Glyoxal | | 1.5 | | | | | 0.5 | 0.5 |
| | Glutaraldehyde | | | 1.2 | | | | | 0.6 |
| | Maleate | | | | | 1.4 | | | |
| Insecticide | Empenthrin | | 1.2 | | | 1.5 | 1.1 | | 1 |
| | Imiprothrin | | | 1 | | | | 0.5 | 0.3 |
| | D-phenothrin | 1.4 | | | 1.3 | | | 0.7 | |
| Anti-fungal | Citral | 0.5 | | | | | | | |
| agent | Bromo cinnamic | | 1.4 | | | | | 1 | |
| | aldehyde | | | | | | | | |
| | Clove oil | | | 1.3 | | | | | 1 |
| | Litsea oil | | | | 1.1 | | | 0.3 | |
| | Propionate | 1 | | | | | | | |
| | Eucalyptus oil | | | | | 1.2 | | | 0.2 |
| | Dodecyl guanidine | | | | | | 1.5 | | |
| | hydrochloride | | | | | | | | |
| Release | β-cyclodextrin | 80 | | | | | | | 70 |
| agent | Gum Arabic | | 60 | | | 100 | | | |
| | Gelatin | | | 80 | | | 90 | | |
| | Polyethylene | | | | 70 | | | 80 | |
| | glycol-8,000 | | | | | | | | |
| Solvent | Ethanol | 10 | 10 | 10 | 10 | 10 | 10 | 10 | 10 |
| Emulsifier | Polysobate-80 | 0.02 | 0.021 | 0.022 | 0.024 | 0.025 | 0.023 | 0.02 | 0.02 |
| Diluent | Distilled water or | 800 | 600 | 800 | 700 | 1000 | 900 | 800 | 700 |
| | deionized water | | | | | | | | |

### EMBODIMENTS 1˜8

The constant-temperature sublimation agent, the anti-bacterial agent, the deodorant, the insecticide, the anti-fungal agent, and the solvent are uniformly mixed at room temperature to produce a functional mixture prepared for use. A release agent is weighed and a diluent is added, heated and uniformly stirred until it dissolves, and then cooled to 60° C. An emulsifier and the functional mixture are added and embedded in the 500 W supersonic condition for 30˜45 min. and then kept overnight, and a homogenization is conducted at the condition of 30 MPa for 4˜5 times, and then a spray-drying process is conducted to obtain the functional microcapsule.

After the functional microcapsule is mixed with pulp to manufacture paper or corrugated cardboards with different weights in grams; or the functional microcapsule and various polymer plastics, natural inorganic mineral powders, and functional additives are mixed, banburied, and processed by lamination and corona to manufacture sheets for making anti-fungal, anti-bacterial, insecticidal and deodorizing shoes package boxes with different models and sizes.

| | | Embodiment | Embodiment | Embodiment | Embodiment | Embodiment | Embodiment | Embodiment | Embodiment |
|---|---|---|---|---|---|---|---|---|---|
| Composition | | 9 | 10 | 11 | 12 | 13 | 14 | 15 | 16 |
| Embodiment 1 | | 25 | | | | | | | |
| Embodiment 2 | | | 20 | | | | | | |
| Embodiment 3 | | | | 22 | | | | | |
| Embodiment 4 | | | | | 21 | | | | |
| Embodiment 5 | | | | | | 24 | | | |
| Embodiment 6 | | | | | | | 22 | | |
| Embodiment 7 | | | | | | | | 23 | |
| Embodiment 8 | | | | | | | | | 25 |
| Film | Water-soluble | 75 | | | | | | | |
| former | polyurethaneresin | | | | | | | | |
| | (Solid Content 35%) | | | | | | | | |
| | Alcohol-soluble | | 70 | | 52 | | | | |
| | acrylic acid resin | | | | | | | | |
| | Rosin resin | | | 30 | | | 42 | | |
| | Polyvinyl alcohol | | | | 20 | | | 59 | |
| | (Hydroxyphenyl) | | | 41 | | 15 | | | 36 |
| | methyl cellulose | | | | | | | | |
| | Ethyl cellulose | | | | | | 30 | | |
| | Modified starch | | | | | 58 | | 15 | |
| | Polyvinylpyrrolidone | | | | | | | | 35 |
| Solvent | Ethanol | | 45 | 45 | | | 45 | | 20 |
| Diluent | Distilled water or | | | | 80 | 75 | | 75 | 20 |
| | deionized water | | | | | | | | |

### EMBODIMENT 9

The functional microcapsule manufactured in accordance with Embodiment 1 is added into the water-soluble polyurethaneresin solution and uniformly stirred and mixed at room temperature, and then sprayed or coated onto the inner surface of a shoes box to obtain the anti-fungal, anti-bacterial, insecticidal and deodorizing shoes package box.

### EMBODIMENT 10

The alcohol-soluble acrylic acid resin and the solvent are stirred at room temperature until they are completely dissolved, and the functional microcapsule manufactured in accordance with Embodiment 2 is added and uniformly stirred and mixed at room temperature, and then sprayed or coated onto the inner surface of a shoes box to obtain the anti-fungal, anti-bacterial, insecticidal and deodorizing shoes package box.

### EMBODIMENT 11

Rosin resin and the solvent are stirred at room temperature until they are completely dissolved, and the functional microcapsule manufactured in accordance with Embodiment 3 is added and uniformly stirred and mixed at room temperature, and then sprayed or coated onto the inner surface of a shoes box to obtain the anti-fungal, anti-bacterial, insecticidal and deodorizing shoes package box.

### EMBODIMENT 12

Polyvinyl alcohol and the diluent are stirred at 95° C. until they are completely dissolved, and then cooled to 40° C., and the functional microcapsule manufactured in accordance with Embodiment 4 is added and then uniformly stirred and mixed at room temperature, and sprayed or coated onto the inner surface of a shoes box to obtain the anti-fungal, anti-bacterial, insecticidal and deodorizing shoes package box.

### EMBODIMENT 13

(Hydroxyphenyl) methyl cellulose and the diluent are stirred at room temperature until they are completely dissolved, and the functional microcapsule manufactured in accordance with Embodiment 5 is added and uniformly stirred and mixed at room temperature and sprayed or coated onto the inner surface of a shoes box to obtain the anti-fungal, anti-bacterial, insecticidal and deodorizing shoes package box.

### EMBODIMENT 14

Ethyl cellulose and the solvent are stirred at room temperature until they are completely dissolved, and the functional microcapsule manufactured in accordance with Embodiment 6 is added and uniformly stirred and mixed at room temperature and sprayed or coated onto the inner surface of a shoes box to obtain the anti-fungal, anti-bacterial, insecticidal and deodorizing shoes package box.

### EMBODIMENT 15

Modified starch and the diluent are stirred at room temperature until they are completely dissolved, and the functional microcapsule manufactured in accordance with Embodiment 7 is added and uniformly stirred and mixed at room temperature and sprayed or coated onto the inner surface of a shoes box to obtain the anti-fungal, anti-bacterial, insecticidal and deodorizing shoes package box.

### EMBODIMENT 16

Polyvinylpyrrolidone, the diluent, and the solvent are stirred at room temperature until they are completely dissolved, and the functional microcapsule manufactured in accordance with Embodiment 8 is added and uniformly stirred and mixed at room temperature and sprayed or coated onto the inner surface of a shoes box to obtain the anti-fungal, anti-bacterial, insecticidal and deodorizing shoes package box.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. A high-performance anti-fungal, anti-bacterial, insecticidal and deodorizing microcapsule, comprising the following raw materials in parts by weight: a constant-temperature sublimation agent of 40˜50 parts by weight, an anti-bacterial agent of 10˜15 parts by weight, a deodorant of 10˜15 parts by weight, an insecticide of 10˜15 parts by weight, an anti-fungal agent of 10˜15 parts by weight, a solvent of 100 parts by weight, a release agent of 600˜1000 parts by weight, a diluent of 6000˜10000 parts by weight, and an emulsifier of 0.2˜0.25 part by weight.

2. The high-performance anti-fungal, anti-bacterial, insecticidal and deodorizing microcapsule as claimed in claim 1, wherein the anti-bacterial agent is one selected from the group consisting of hinokitiol, citronellal, thymol, bronopol, pyridine zinc sulfate, stable chlorine dioxide solution, and any mixture thereof.

3. The high-performance anti-fungal, anti-bacterial, insecticidal and deodorizing microcapsule as claimed in claim 1, wherein the anti-fungal agent is one selected from the group consisting of citral, bromo cinnamic aldehyde, clove oil, litsea oil, eucalyptus oil, propionate, O-phenylphenol, dodecyl guanidine hydrochloride, and any mixture thereof.

4. The high-performance anti-fungal, anti-bacterial, insecticidal and deodorizing microcapsule as claimed in claim 1, wherein the deodorant is one selected from the group consisting of chitin, chitosan, glyoxal, glutaraldehyde, maleate, and any mixture thereof.

5. The high-performance anti-fungal, anti-bacterial, insecticidal and deodorizing microcapsule as claimed in claim 1, wherein the insecticide is one selected from the group consisting of empenthrin, imiprothrin, D-phenothrin, and any mixture thereof.

6. The high-performance anti-fungal, anti-bacterial, insecticidal and deodorizing microcapsule as claimed in claim 1, wherein the constant-temperature sublimation agent is one selected from the group consisting of 2,4,6-triisopropylsilyl-1,3,5-three oxygen-dioxane, 2-hydroxy camphor, adamantane, and any mixture thereof.

7. The high-performance anti-fungal, anti-bacterial, insecticidal and deodorizing microcapsule as claimed in claim 1, wherein the release agent is one selected from the group consisting of β-cyclodextrin, gelatin, gum Arabic, shellac, kerria, starch, dextrin, wax, turpentine, alginate, (hydroxyphenyl) methyl cellulose, ethyl cellulose, polyethylene, polystyrene, polybutadiene, polyether, polyurea, polyethylene glycol, polyvinyl alcohol, polyamide, polyacrylamide, polyurethane, polymethyl methacrylate, polyvinylpyrrolidone, epoxy resin, polysiloxane, and any mixture thereof.

8. An application of a high-performance anti-fungal, anti-bacterial, insecticidal and deodorizing microcapsule, characterized in that a functional microcapsule is added into pulp, and the added amount is equal to 10˜20 parts by weight to manufacture paper or corrugated cardboards with different weights in grams, so as to produce sheets of a shoes box.

9. An application of a high-performance anti-fungal, anti-bacterial, insecticidal and deodorizing microcapsule, characterized in that a functional microcapsule of 20˜25 parts by weight and a film former of 70˜75 parts by weight are thoroughly stirred and mixed at room temperature and then sprayed or coated onto the inner surface of a shoes box, and the sprayed or coated amount is equal to 600˜800 g per cubic meter.
